(19) United States
(12) Patent Application Publication
(10) Pub. No.: US 2010/0097282 A1
(43) Pub. Date: Apr. 22, 2010

(54) MULTI-BAND COMPACT ANTENNA SYSTEM FOR HANDHELD DEVICES

(75) Inventor: Laurian Petru Chirila, Irvine, CA (US)

Correspondence Address: HESLIN ROTHENBERG FARLEY & MESITI PC, 5 COLUMBIA CIRCLE, ALBANY, NY, 12203, US

(73) Assignee: PSION TEKLOGIX INC., Mississauga (CA)

(21) Appl. No.: 12/256,185

(22) Filed: Oct. 22, 2008

(51) Int. Cl. H01Q 13/00; H01Q 1/38

(52) U.S. Cl. 343/770; 343/700 MS

(57) ABSTRACT

A multi-band antenna and a handheld device with multi-band antenna are provided. The multi-band antenna includes a radiating layer having a first radiating antenna pattern for a plurality of first bands, a second radiating antenna pattern for a plurality of a second bands, and a third radiating antenna pattern for a third band; a ground layer; a dielectric layer sandwiched between the ground layer and the radiating layer. The handheld device includes a multi-band antenna board having a plurality of antenna patterns having a GPS radiating antenna pattern, a low bands radiating antenna pattern and a high bands radiating antenna pattern, the low bands radiating antenna pattern or the high bands radiating antenna pattern being formed between the other radiating antenna patterns.

### FIELD OF INVENTION

The present invention relates to antenna systems, and more specifically to multi-band antenna systems for handheld devices.

### BACKGROUND OF THE INVENTION

A number of communication standards/services (e.g., Global System for Mobile (GSM), Universal Mobile Telecommunications System (UMTS), Global Positioning System (GPS), WiFi, Bluetooth etc) have been developed for wireless communication devices, such as handheld devices. Especially, the demand for a handheld device (e.g., Personal Digital Assistant (PDA)) operable for multiple communication standards has been rapidly expanded. Using the multiple communication standards, global customers can use the same device anywhere in the world.

Conventionally, the handheld device needs to employ multiple antennas in order to support multiple communication standards. However, this costs a lot of trouble in designing, ordering, manufacturing the device.

There is a need to provide a multi-band compact antenna and a handheld device for the multi-band compact antenna that can support multiple communication standards.

### SUMMARY OF THE INVENTION

It is an object of the invention to provide a multi-band antenna system that obviates or mitigates at least one of the disadvantages of existing systems.

According to an aspect of the present invention there is provided a multi-band antenna which includes: a radiating layer having a first radiating antenna pattern for a plurality of first bands; a second radiating antenna pattern for a plurality of second bands, and a third radiating antenna pattern for a third band; and a ground layer; and a dielectric layer sandwiched between the ground layer and the radiating layer.

According to another aspect of the present invention there is provided a handheld device which includes: a multi-band antenna board having a plurality of antenna patterns having a GPS radiating antenna pattern, a low bands radiating antenna pattern and a high bands radiating antenna pattern, the low bands radiating antenna pattern or the high bands radiating antenna pattern being formed between the other radiating antenna patterns; and components for wireless communications having an audio speaker, a microphone and a processor for the operation of the handheld device, the audio speaker and the microphone being placed on the front side of the handheld device. The multi-band antenna board is placed into the handheld device so that the front side of the handheld device is closer to the GPS radiating antenna pattern than the low bands radiating antenna pattern and the high bands radiating antenna pattern.

### BRIEF DESCRIPTION OF THE DRAWINGS

These and other features of the invention will become more apparent from the following description in which reference is made to the appended drawings wherein:

FIG. 1 is a perspective front view of an example of a handheld device with a multi-band antenna in accordance with an embodiment of the present invention, with a front cover;

FIG. 2 is a perspective view of front side components in the handheld device of FIG. 1 with the front cover and a rubber gasket;

FIG. 3 is a perspective side top view of the handheld device of FIG. 2;

FIG. 4 is another perspective side top view of the handheld device of FIG. 2 with the front cover;

FIG. 5 is a perspective top view of the handheld device of FIG. 2;

FIG. 6 is a perspective front view of the handheld device of FIG. 1 with the front cover, the back cover and the rubber gasket;

FIG. 7 is another perspective front view of the handheld device of FIG. 6;

FIG. 8 is a bottom view of the handheld device of FIG. 6;

FIG. 9 is a perspective back view of the handheld device of FIG. 6;

FIG. 10 is another perspective back view of the handheld device of FIG. 6;

FIG. 11 is a further perspective back view of the handheld device of FIG. 6 and a battery cover of the handheld device;

FIG. 12 is a cross sectional view of an example of the multi-band antenna applied to the handheld device of FIG. 1;

FIG. 13 is an example of a dielectric layer of the multi-band antenna of FIG. 1;

FIG. 14 is a view of a ground plane antenna pattern in the multi-band antenna of FIG. 1;

FIG. 15 is a view of a radiating plane antenna pattern in the multi-band antenna of FIG. 1;

FIG. 16 is a front view of the multi-band antenna of FIG. 1;

FIG. 17 is a back view of the multi-band antenna of FIG. 16;

FIG. 18 is another back view of the multi-band antenna of FIG. 1 with antenna cables;

FIG. 19 is another front view of the multi-band antenna of FIG. 18;

FIG. 20 is a view showing the handheld device of FIG. 1 with the multi-band antenna of FIGS. 12-19;

FIG. 21 shows a return loss graph for GPS measurement for the multi-band antenna of FIGS. 12-19;

FIG. 22 shows a return loss graph for GMS, GPRS, UMTS bands measurement for the multi-band antenna of FIGS. 12-19;

FIG. 23 is a perspective view of a WiFi antenna applied to the handheld device of FIG. 1, with a WiFi cable;

FIG. 24 shows a return loss graph for the WiFi antenna of FIG. 23; and

FIG. 25 shows a simulated 3-D radiation pattern example for high bands from the multi-band antenna and the WiFi antenna.

### DETAILED DESCRIPTION

One or more currently preferred embodiments have been described by way of example. It will be apparent to persons skilled in the art that a number of variations and modifications can be made without departing from the scope of the invention as defined in the claims.

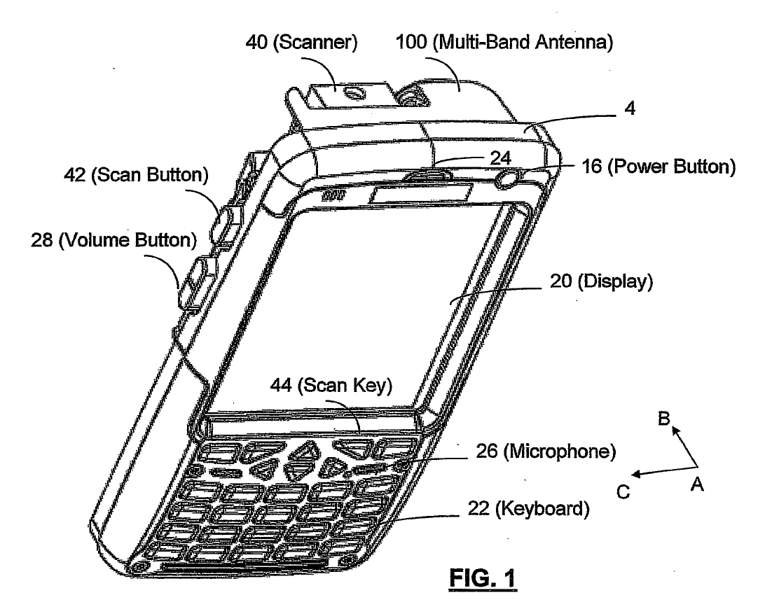

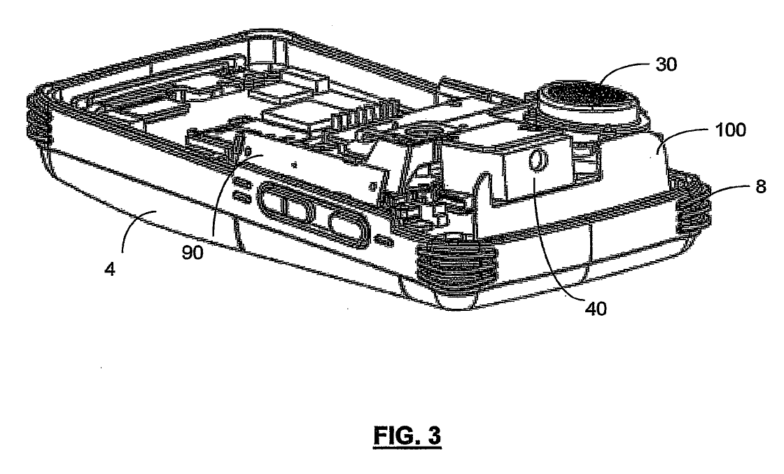

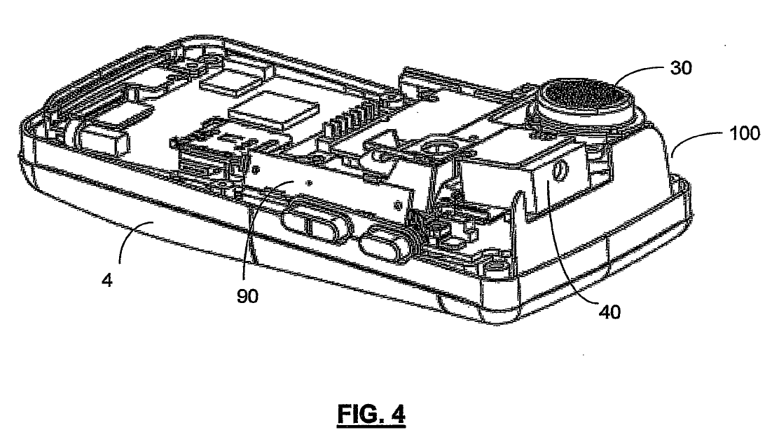

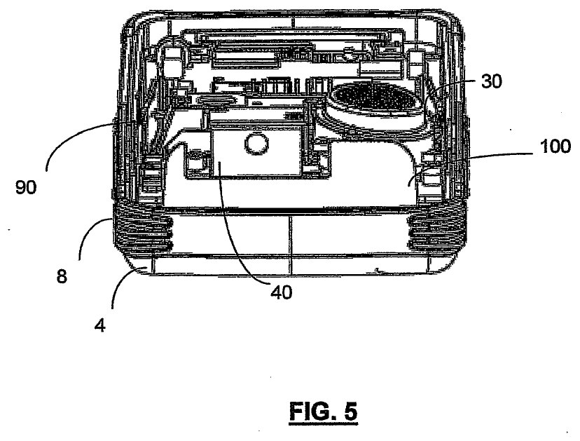

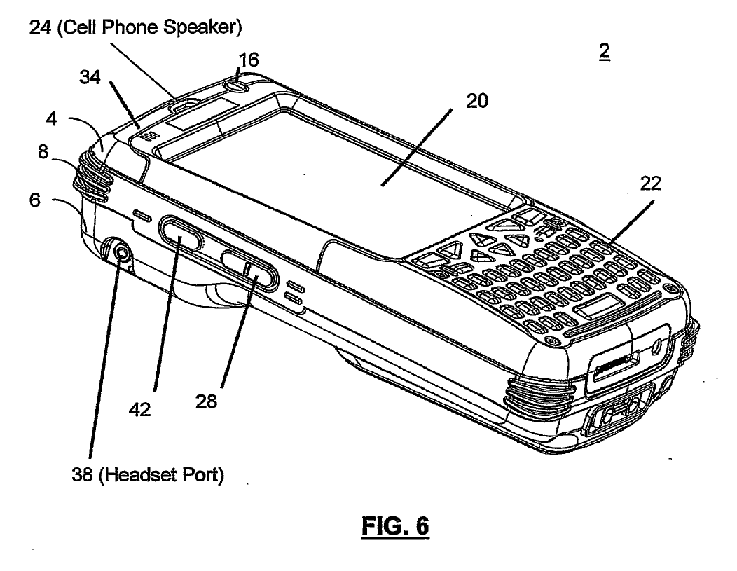

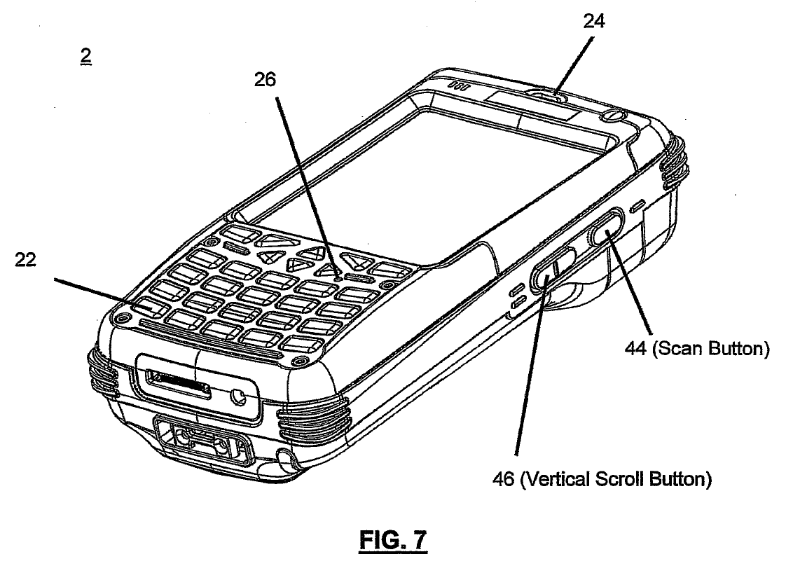

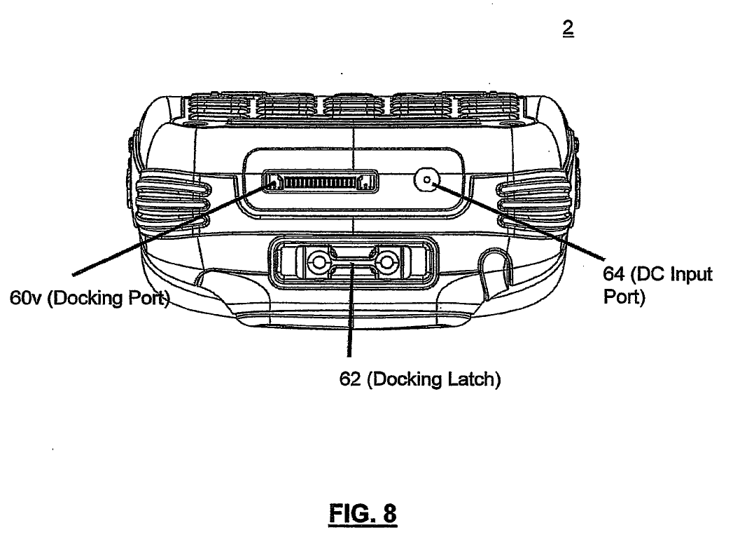

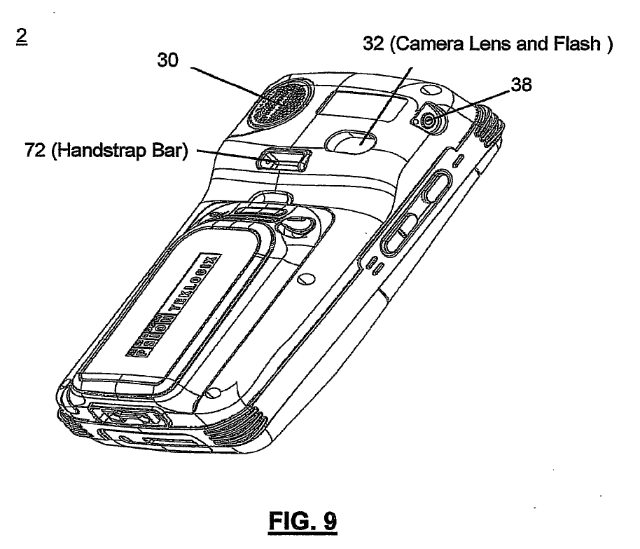

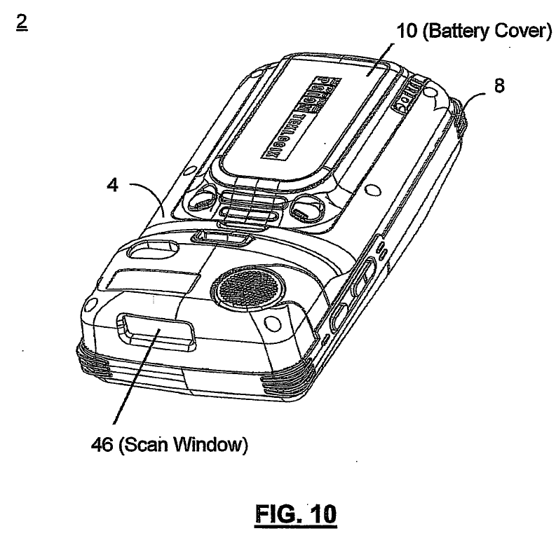

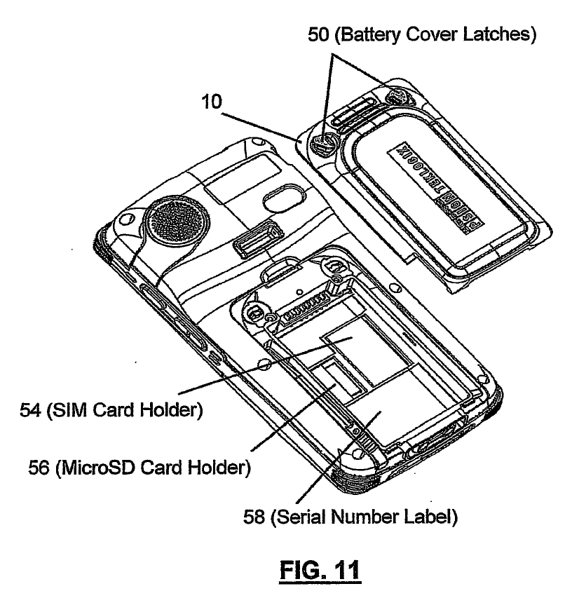

Referring to FIGS. 1-10, a handheld device with a multi-band antenna is described in detail. The handheld device 2 of FIGS. 1-12 is a palm sized portable computer, e.g., a personal digital assistant (PDA). In the description, the terms “portable” and “handheld” are used interchangeably. As described below, the multi-band antenna is an integrated miniature antenna for supporting operations of the handheld device 2 with multi-bands.

The handheld device 2 includes a cover having a front cover 4, a back cover 6, a gasket 8, and a battery cover 10. The gasket 8 is a rubber gasket in an H form to seal the front cover 4 and the back cover 6. In the description, the terms “cover”, “housing” and “enclosure” are used interchangeably.

The handheld device 2 includes one or more data acquisition and communication components. The one or more data acquisition and communication components include, for example, a display 20, a keyboard 22 having a plurality of keys, a cell phone audio speaker 24, and a microphone 26 for the cell phone functionality, a volume button 28 for controlling an audio speaker level, a speaker 30, a camera (camera lens and flash) 32, a visual indicator (LED) 34. In the description, the terms “cell phone” and “mobile phone” are used interchangeably.

The one or more data acquisition and communication components of the handheld device 2 further include, for example, a scanner 40 (e.g., barcode scanner). The cover has a scanner window 46 for the scanner 40. The one or more data acquisition and communication components of the handheld device 2 further include scan buttons 42, 43, scan keys 44, a scroll button 46. The handheld device 2 turns on/off by a power button 16.

The battery cover 10 has cover latches 50 for connecting the battery cover 10 to the back cover 6. One of ordinary skill in the art could appreciate that the handheld device 2 includes a battery for supplying power to the components of the handheld device 2.

The handheld device 2 includes modules/electronics for the operations of the handheld device 2, such as a processor, a memory and an interface for wireless/wired communications with external devices (e.g., server, other handheld devices). The processor may include a module for processing data/signals acquired. For example, the handheld device 2 includes a SIM card (SIM card holder 54) for the cell phone functionality, and a SD memory card (MicroSD card holder 56). The handheld device 2 further includes a docking port 60 and a docking latch 62 for docking, and a DC input port 64.

The handheld device 2 has a built-in GPS, GSM, GPRS, UMTS, WiFi and Bluetooth connectivity options. One of ordinary skill in the art could appreciate the operation of each of the connectivity options.

The handheld device 2 further includes components, such as a headset port 38 and a handstrap bar 72. One of ordinary skill in the art could appreciate that the handheld device 2 may include further modules/electronics/circuit boards for operating the handheld device 2, not illustrated in the drawings.

In the description, for clarity and without loss of generality, the side of the handheld device 2 having the cell phone audio speaker 24 and the microphone 26 (cell phone functionality) is referred to as a front side of the handheld device 2. The back side of the handheld device 2 is the side opposite to the front face of the handheld device 2. As well understood by one of ordinary skill in the art, the handheld device 2 further has its top (side), bottom side and left/right side.

In the drawings, “A” refers to the front side of the handheld device 2, “B” refers to the back side of the handheld device 2, and “C” refers to one side of the handheld device 2.

The data acquisition components are placed on the front side of the handheld device 2. The user's head of the handheld device 2 is close to the front side of the handheld device 2 when the handheld device 2 is used as a cell phone.

The handheld device 2 includes a WiFi antenna 90 and a multi-band antenna 100. Each of the WIFi antenna 90 and the multi-band antenna 100 is designed as an internal antenna so that it can be integrated in the handheld device 2. The outline of the multi-band antenna 100 is designed so that it is adapted to fit the handheld device 2. For example, the multi-band antenna 100 is designed to fit in the space of 23.6×60×0.85 mm.

The multi-band antenna 100 is an integrated miniature antenna for supporting the handheld device 2 that operates in a plurality of frequency bands. The multi-band antenna 100 is, for example, a 6 band high performance miniature antenna as described below. The multi-band antenna 100 is placed on the top front side of the handheld device 2 and is close to the cell phone audio speaker 24.

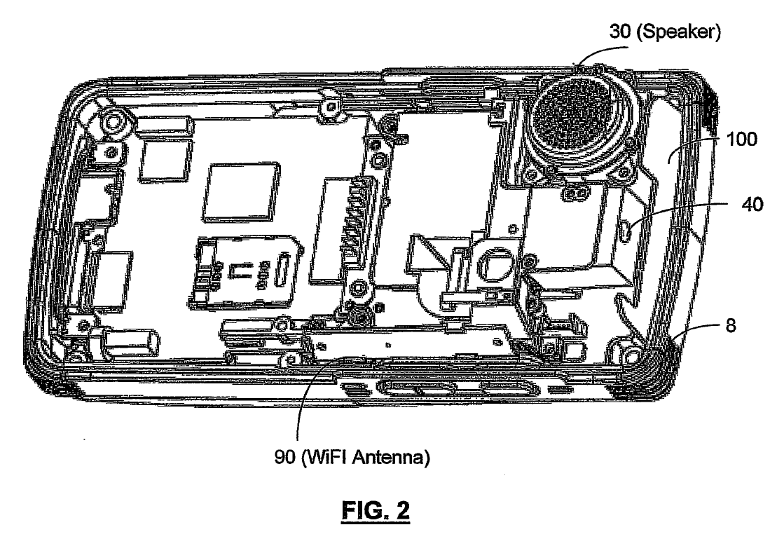

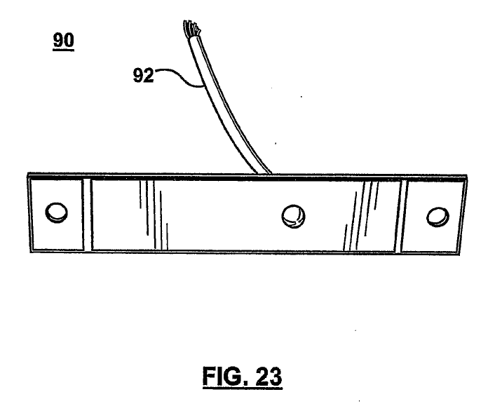

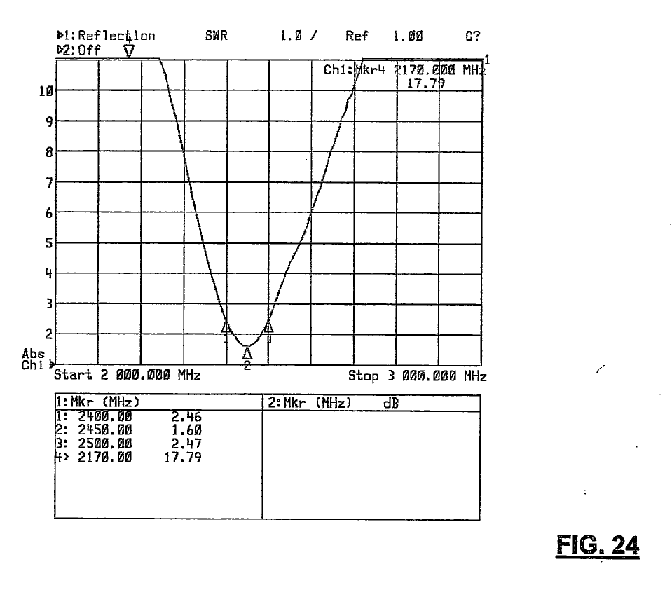

The WiFi antenna 90 has an antenna body and a cable 92 as shown in FIG. 23. The WiFi antenna is placed on the left side of the handheld device 2 in FIGS. 2-5. The WiFI antenna 90 has an antenna pattern, for example, as shown in FIG. 24.

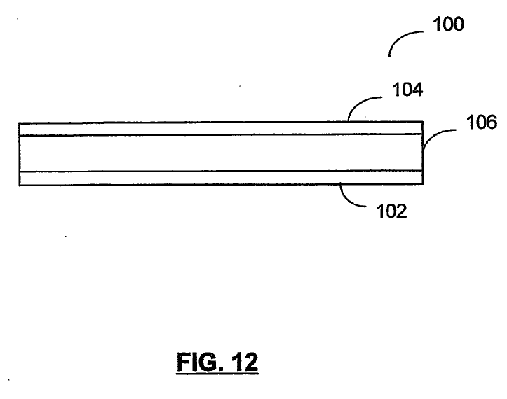

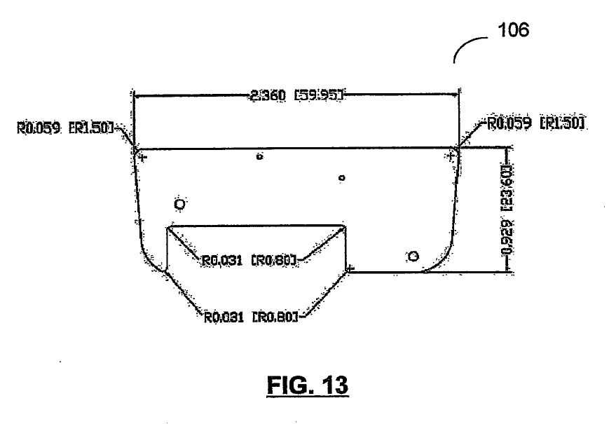

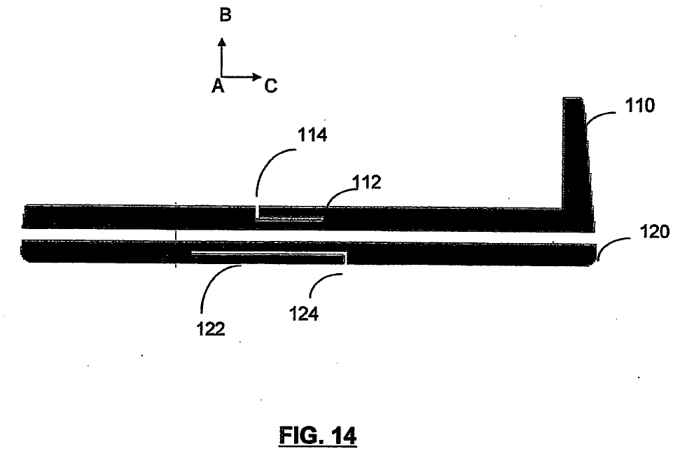

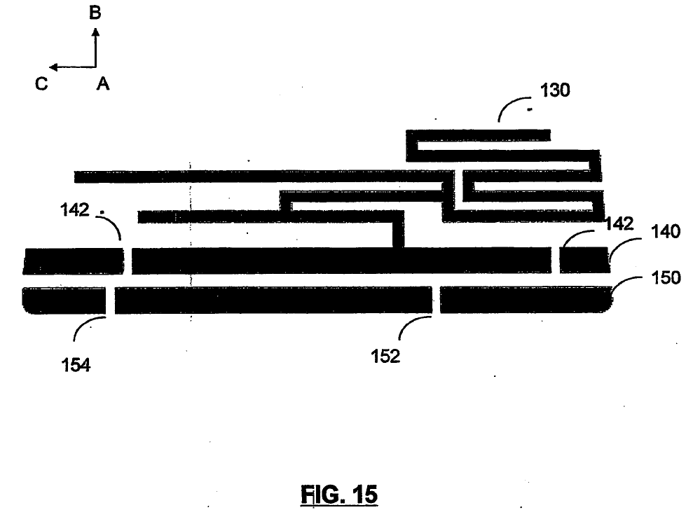

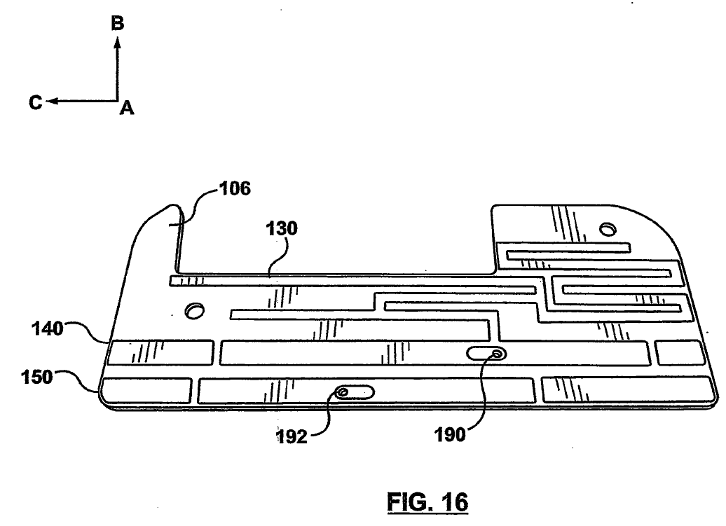

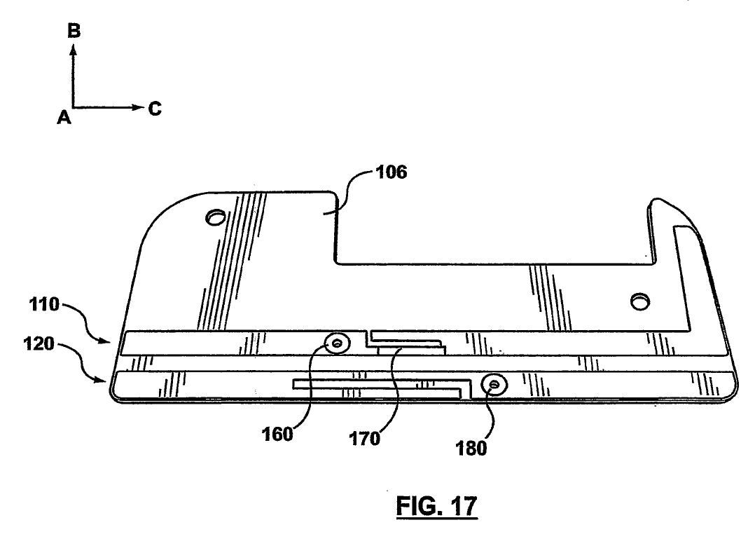

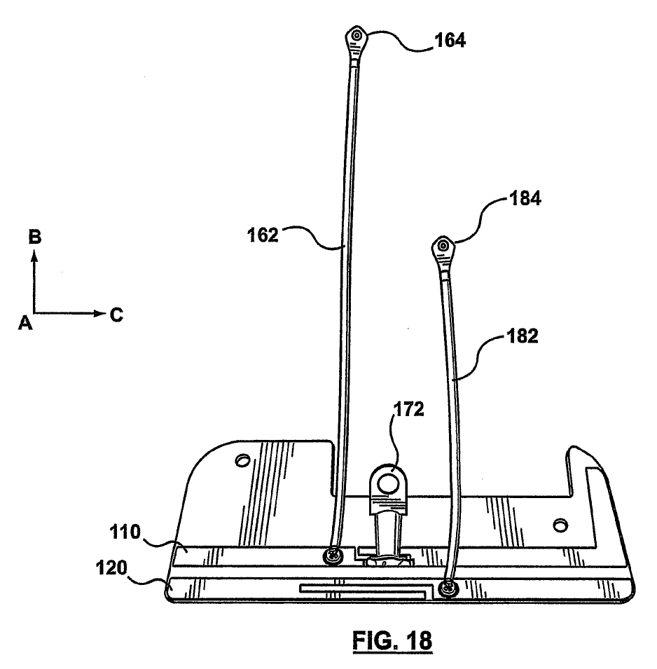

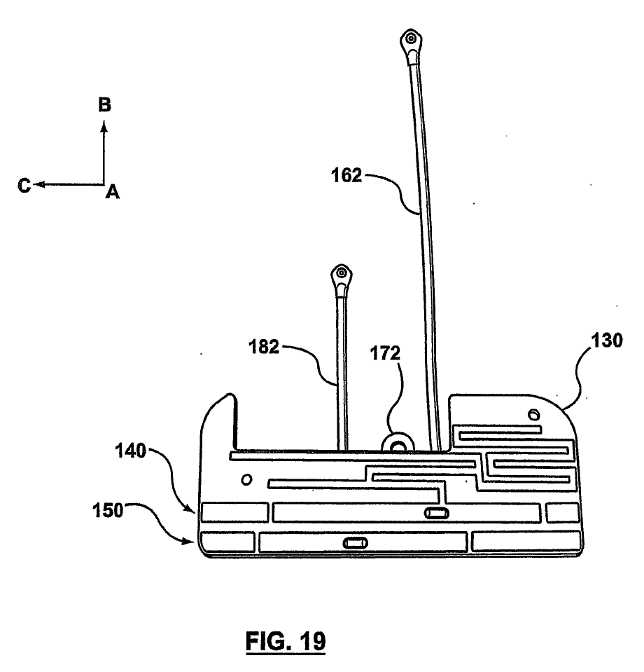

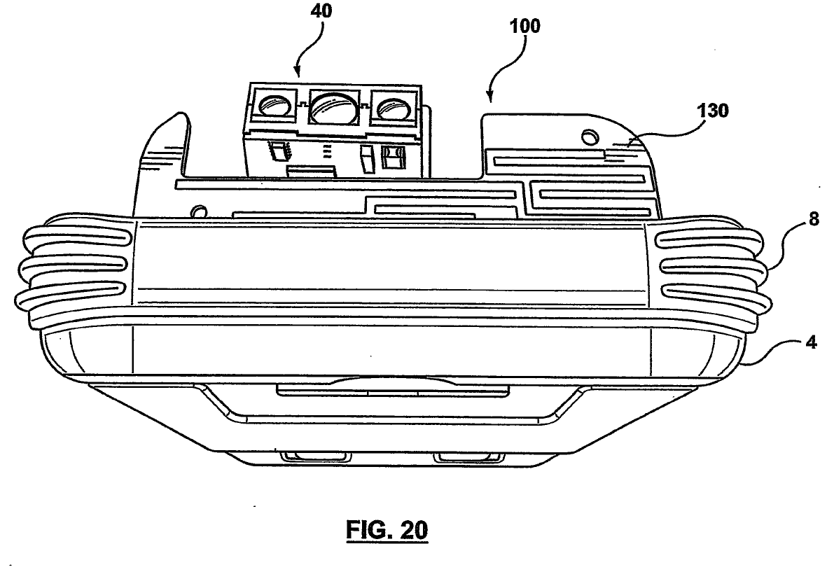

Referring to FIGS. 12-22, an example of the multi-band antenna 100 is described in detail. The multi-band antenna 100 of FIGS. 12-22 is a 6 band high performance miniature antenna and includes a GPS antenna area, a high bands antenna area and a low bands antenna area, as described in detail below. In this example, the high bands are 1800 MHz band, 1900 MHz band and 2100 MHz band. In this example, the low bands are 850 MHz band and 900 MHz band. It would be understood by one of ordinary skill in the art that each of the bands has an operation range covering the specific frequency. The multi-band antenna 100 is a compact antenna board that is inserted into the handheld device 2.

The GPS antenna of the multi-band antenna 100 is a receiving antenna. The center frequency of the GPS antenna may be, for example, but not limited to, 1,575.42 MHz. The GPS antenna only receives energy and does not radiate energy. The low bands and high bands antennas are used for transmission and reception of electromagnetic energy by converting radio waves into electrical signals vice versa.

The multi-band antenna 100 is designed so that the GPS antenna area is closer to the front side of the handheld device (2), than the low bands and high bands antenna areas, when it is mounted on the front top side of the handheld device (2).

The high band antenna of the multi-band antenna 100 is placed next to the GPS antenna. The high band antenna is a high frequency slotted patch (directional) antenna. The high band antenna may be a directional antenna disclosed in U.S. Pat. No. 7,050,009, which is incorporated herewith by reference. The high band antenna is positioned in the complex antenna structure to minimize the amount of energy blasted towards the human head when the handheld device 2 is used as a cell phone. The least energy is radiated towards the human head, especially human hearing passage through the head scull. The low band antenna is located next to the high band antenna. The low band antenna is a branched meander line antenna.

The data acquisition components (cell phone functionality) of the handheld device (2) are placed on the top front side of the handheld device (2). Thus, in the handheld device (2), the GPS antenna of the multi-band antenna 100 is placed in the best position for receiving the energy when the handheld device (2) is used as a data terminal.

In addition, the GPS antenna of the multi-band antenna 100 is the closest to the human head when the handheld device (2) is used as a cell phone. The position of the GPS antenna reduces the amount of energy to which the human head is exposed when talking on the handheld device (2).

In FIGS. 12-22, the high bands antenna pattern is located next to the GPS antenna pattern. However, the low bands antenna pattern may be located next to the GPS antenna pattern.

The multi-band antenna 100 includes a bottom conductive layer 102 (referred to as “ground plane 102”), a top conductive layer 104 (referred to as “radiating plane 104”), and a thick radio frequency (RF) grade dielectric 106 sandwiched between, for example, positioned between, the ground plane 102 and the radiating plane 104. The width of the dielectric layer 106 is wider than those of the ground plane 102 and the radiating plane 104. In one example, each of the ground plane 102 and the radiating plane 104 is 0.0014″ (0.035 mm) thin, and the dielectric layer 106 is 0.030″ (0.75 mm) thick in width.

The ground plane 102 and the radiating plane 104 are thin layers so that the overall size and weight of the multi-band antenna 100 are suitable for handheld devices (e.g., 2). The outline of the antenna 100 is adapted to the handheld device (2) in order to use at maximum the available internal area of the handheld device (2). In this example, the antenna 100 is designed so that the scanner device (40) and the multi-band antenna 100 can be placed on the top side of the handheld device (2). The dielectric layer 106, the ground plane 102, and the radiating plane 104 may be formed into a non-flat shape e.g., curved, so as to fit into a specific space of the handheld device.

In this example, the dielectric layer 106 is the substrate portion of a printed circuit board (PCB). The PCB material is, for example, not limited to, TACONIC RF-32-0300-S1/S1 that is a 0.030″ thick double sided PCB (with copper on each side) built on a substrate material with a dielectric constant of 3.2.

In another example, the dielectric layer 106 may be another non-conductive material such as a silicon wafer or a rigid or flexible plastic material.

In this example, the ground plane 102 and the radiating plane 104 are copper layers. The ground plane 102 and the radiating plane 104 may be created by covering the substrate dielectric layer 106, through lamination, roller-cladding.

The ground plane 102 includes a low and high bands ground plane 110 and a GPS ground plane 120. The radiating plane 104 includes a low bands radiating plane 130, a high bands radiating plane 140, and a GPS radiating plane 150. The low bands radiating plane 130 and the high bands radiating plane 140 are connected to each other.

In this example, the low and high bands ground plane 110 includes a L-shaped ground slot that has a leg 112 extending parallel to the longitudinal axis A-C of the antenna and a leg 114 extending the axis A-B traverse to the axis A-C. The axial leg 112 and the transverse leg 114 of the slots are aligned with one another.

In this example, the GPS ground plane 120 includes a L-shaped ground slot that has a leg 122 extending parallel to the longitudinal axis A-C of the antenna and a leg 124 extending the axis A-B traverse to the axis A-B. The axial leg 122 and the transverse leg 124 of the slots are aligned with one another.

The low bands radiating plane 130 has a meander line structure having a plurality of branch strips that has horizontal and vertical conductors with gaps. The high bands radiating plane 140 includes radiating slots 142 and 144 extending the axis A-B. The GPS radiating plane 150 includes radiating slots 152 and 154 extending the axis A-B.

The source slots and ground slots are created by etching, or otherwise removing, conductive material from the conductive planes 112 and 114 respectively. The branch strips and slots are designed for specific resonance frequencies.

The low and high bands ground plane 110 has a connection point (terminal) 160 for connecting a low and high bands antenna cable 162. The connection point 160 is a feed point for the low and high bands antenna. The other end of the low and high bands antenna cable 162 has an antenna port 164. The low and high bands ground plane 110 has a connection point (terminal) 170 for connecting a low bands extra connection 172. The connection point 170 is a main ground point for connecting to the terminal and is directed to a main logic board of the handheld device 2. The GPS ground plane 120 has a connection point (terminal) 180 for connecting a GPS antenna cable 182. The connection point 180 is a feed point for the GPS antenna. The other end of the GPS antenna cable 182 has an antenna port 184.

The high bands radiating plane 140 has a connection point (terminal) 190 at which the low and high bands antenna cable 162 is terminated. The GPS radiating plane 150 has a connection point (terminal) 192 at which the GPS antenna cable 182 is terminated.

The lower bands antenna part has multi-frequency operation stemming from multi resonances for 850 MHz band and 900 MHz band. The branch strips of the meander line are designed to have resonances for these bands.

The high bands antenna part has multi-frequency operation stemming from multi resonances for 1800 MHz band, 1900 MHz band, and 2100 MHz band.

The high bands antenna of the multi-band antenna 100 exhibits a radiation pattern that tends to be directional, which is null along the axis of the antenna 100, so as to inhibit the intensity of radiation emanating from the ground plane 102.

It is well understood by one of ordinary skill in the art that the high band frequency range (e.g., 1710-2180 MHz) is the most dangerous for the human body, especially the human head. By using the directional high band antenna, the radiation energy is not blasting directly in the user's head. The high bands are used in the highly dense populated areas and highly converted in order to address the high numbers of users and not focused for long range. For long range on low densely populated areas the low bands (824-960 MHz) are used and these low frequencies are not proved to be harmful to the human health.

One of ordinary skill in the art could appreciate that the operating frequencies are adjusted by optimizing the dimensions of the antenna patterns and arrangements related to each other. For example, the length of each branch of the meander line antenna (low bands antenna) is determined based on the desired operation bands. For example, the high bands antenna pattern has a straight structure that is sufficient long enough for the desired high bands operations. For example, each antenna pattern and the structure of connecting the low bands antenna pattern and the high bands antenna pattern may be adjusted based on the desired bandwidth and return loss. The relative positioning and sizing of the slots on the radiating plane 140 for the high bands the ground plane 110 may be adjusted so as to enhance the radiation intensity in the forward direction and reduce the radiation intensity in the backward direction. This may be accomplished by considering the relative phases of the radiation component from each plane. Similarly, the spacing between the planes may be adjusted to optimize the interaction of the radiation from each plane to attain the desired radiation pattern.

The impedance of each antenna may be: 50 Ohms for the low bands antenna; 50 Ohms for the high bands antenna; 50 Ohms for the GPS antenna. Voltage Standing Wave Ratio (VSWR) of each antenna may be: <3:1 over the specified frequency range for the low bands antenna; <3:1 over the specified frequency range for the high bands antenna; <3:1 over the specified frequency range for the GPS antenna. The gain of each antenna may be: 0 dBi for the low bands antenna; 1.9 dBi for the high bands antenna; 1.9 dBi for the GPS antenna.

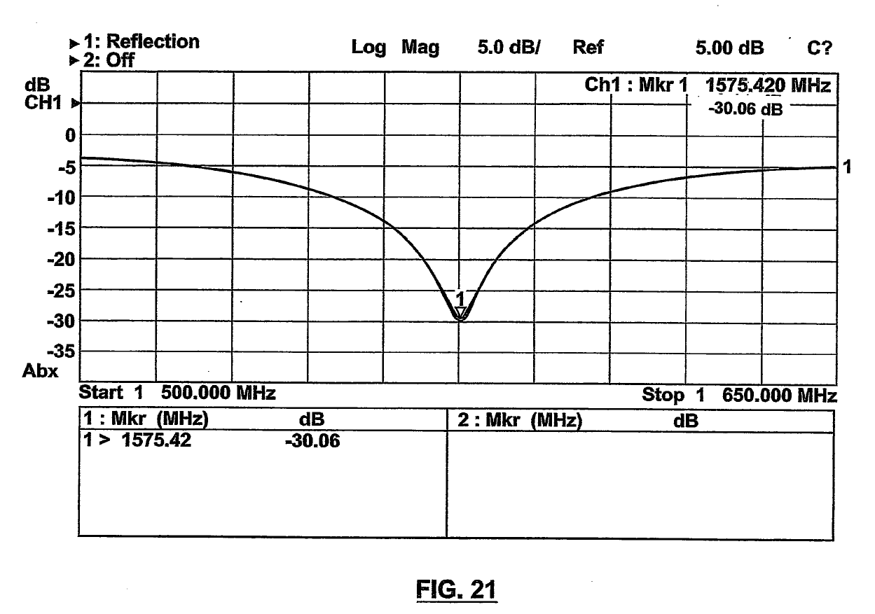

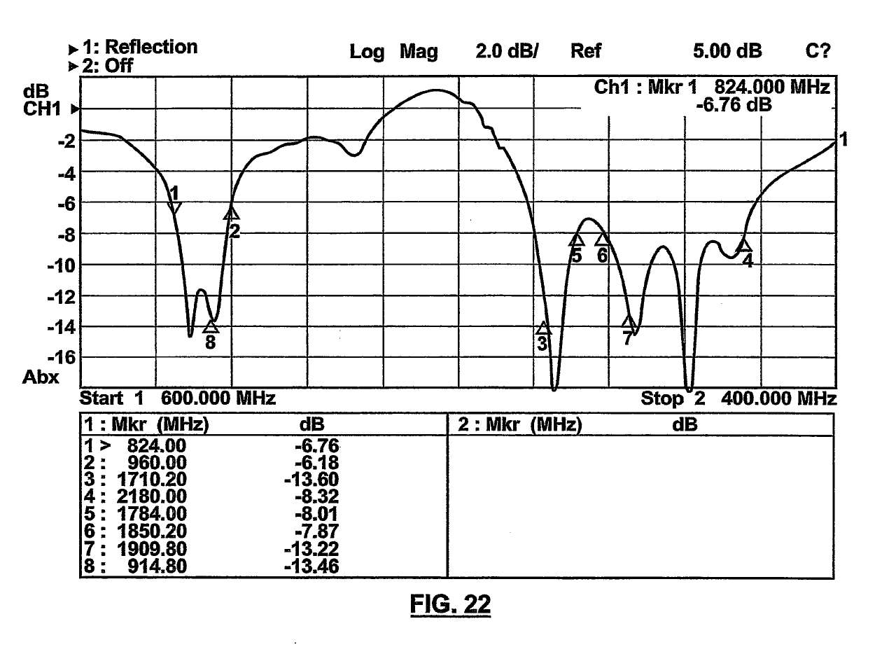

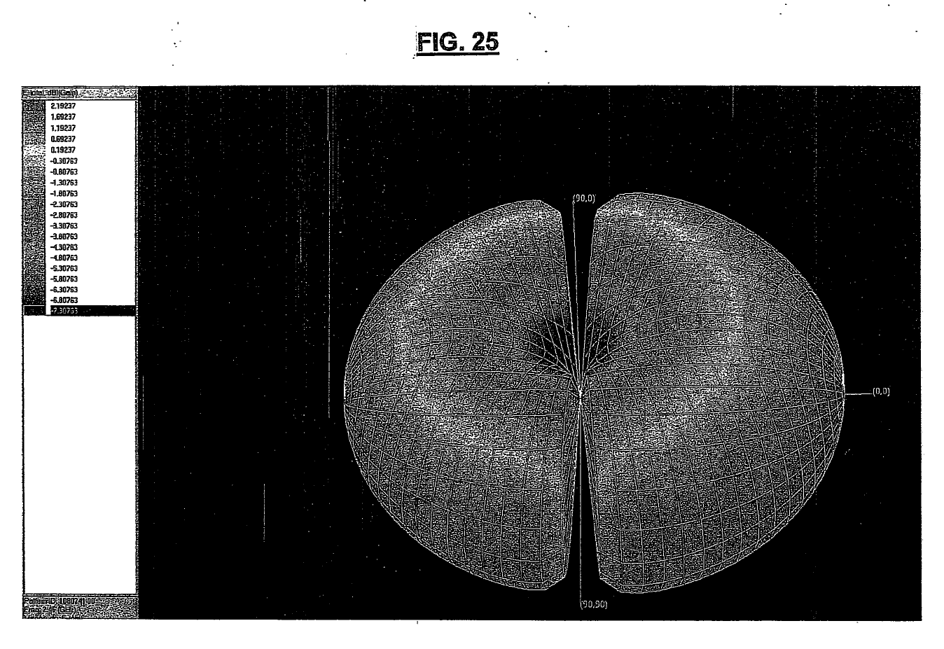

As know by a person skilled in the art, the return loss is used as a performance parameter to quantify the percentage of power that will be reflected at the input of the antenna. FIG. 21 shows the return loss for GPS measurement using the antenna 100 of FIGS. 12-20. FIG. 22 shows the return loss for GMS, GPRS, UMTS bands measurement using the antenna 100 of GPS antenna in FIGS. 12-20. As shown in FIGS. 21-22, the multi-band antenna 100 provides desirable transmission/reception characteristics at GPS, GMS, GPRS, UMTS bands. In addition, FIG. 25 shows a simulated 3-dimensional radiation pattern example for the high bands from the multi-band antenna 100 and the WiFi antenna 90.

One of ordinary skill in the art would appreciate that the handheld device (2 of FIGS. 1-10) may be custom configured with different types of components: e.g., radios, scanners, imagers, digital cameras, RFID readers. All the different as_Fcombinations are affecting the hardware ground plane structure of the multi-band antenna 100.

What is claimed is:

1. A multi-band antenna comprising:
a radiating layer comprising:
a first radiating antenna pattern for a plurality of first bands;
a second radiating antenna pattern for a plurality of second bands, and
a third radiating antenna pattern for a third band
a ground layer; and
a dielectric layer sandwiched between the ground layer and the radiating layer.

2. A multi-band antenna as claimed in claim 1, wherein the first radiating antenna pattern comprises:
a branched meander line antenna pattern.

3. A multi-band antenna as claimed in claim 1, wherein the second radiating antenna pattern comprises:
a slotted patch antenna pattern.

4. A multi-band antenna as claimed in claim 1, wherein the first radiating antenna pattern comprises a branched meander line antenna pattern, wherein the second radiating antenna pattern comprises a slotted patch antenna pattern, and wherein the first radiating antenna pattern is connected to the second radiating antenna pattern.

5. A multi-band according to claim 1, wherein the ground layer comprises:
a first ground antenna pattern for the first radiating antenna pattern and the second radiating antenna pattern; and
a second ground antenna pattern for the third radiating antenna pattern.

6. A multi-band according to claim 5, further comprising:
a first signal line connected to the first ground antenna pattern; and
a second signal line connected to the second ground antenna pattern.

7. A multi-band according to claim 1, wherein the first bands comprise an 850 MHz band and a 900 MHz band.

8. A multi-band according to claim 1, wherein the second bands comprise an 1800 MHz band, a 1900 MHz band, and a 2100 MHz band.

9. A multi-band according to claim 1, wherein the third band comprises a GPS band.

10. A multi-band according to claim 1, wherein one of the first antenna pattern and the second antenna pattern is positioned between the other antenna patterns.

11. A handheld device comprising:
a multi-band antenna board having a plurality of antenna patterns comprising a GPS radiating antenna pattern, a low bands radiating antenna pattern and a high bands radiating antenna pattern, one of the low bands radiating antenna pattern and the high bands radiating antenna pattern positioned between the other radiating antenna patterns; and
components for wireless communications comprising an audio speaker, a microphone and a processor for the operation of the handheld device, the audio speaker and the microphone placed on a front side of the handheld device,
wherein the multi-band antenna board is positioned in the handheld device wherein the front side of the handheld device is closer to the GPS radiating antenna pattern than the low bands radiating antenna pattern and the high bands radiating antenna pattern.

12. A handheld device as claimed in claim 11, wherein the first radiating antenna pattern comprises:
a branched meander line antenna pattern.

13. A handheld device as claimed in claim 11, wherein the second radiating antenna pattern comprises:
a slotted patch antenna pattern.

14. A handheld device as claimed in claim 11, wherein the first radiating antenna pattern comprises a branched meander line antenna pattern, wherein the second radiating antenna pattern comprises a slotted patch antenna pattern, and wherein the first radiating antenna pattern is connected to the second radiating antenna pattern.

15. A handheld device according to claim 11, wherein the ground layer comprises:
a first ground antenna pattern for the first radiating antenna pattern and the second radiating antenna pattern; and
a second ground antenna pattern for the third radiating antenna pattern.

16. A handheld device according to claim 15, further comprising:
a first signal line connected to the first ground antenna pattern; and
a second signal line connected to the second ground antenna pattern.

17. A handheld device according to claim 11, wherein the first bands comprise a 850 MHz band and a 900 MHz band.

18. A handheld device according to claim 11, wherein the second bands comprise a 1800 MHz band, a 1900 MHz band, and a 2100 MHz band.

19. A handheld device according to claim 11, wherein the third band comprises a GPS band.

20. A handheld device according to claim 11, wherein one of the first and the second antenna pattern is positioned between the other antenna patterns.

21. A handheld device according to claim 11, wherein the multi-band antenna board operates for GPS, GMS, GPRS, and UMTS bands.

22. A handheld device according to claim 11, further comprising:
a WiFi antenna board.
